(19) United States
(12) Patent Application Publication
(10) Pub. No.: US 2014/0095191 A1
(43) Pub. Date: Apr. 3, 2014

(54) INTEGRATED LAB MANAGEMENT SYSTEM

(71) Applicant: Issam Kabbani, Torrance, CA (US)

(72) Inventor: Issam Kabbani, Torrance, CA (US)

(21) Appl. No.: 14/040,225

(22) Filed: Sep. 27, 2013

Related U.S. Application Data
(60) Provisional application No. 61/707,471, filed on Sep. 28, 2012.

(51) Int. Cl. G06Q 50/22; G06Q 30/00

(52) U.S. Cl. CPC G06Q 50/22; G06Q 30/018
USPC 705/2

(57) ABSTRACT

The present invention provides an online virtual laboratory manager that allows for electronic documentation and management of all aspects of the laboratory. The system receives data from one or more instruments in a laboratory and stores the data in a central library. The data is compared against compliance target values to determine if the one or more instruments are in compliance, and if the data is out of the compliance target values, notifying a laboratory manager. In notifying the laboratory manager, the laboratory manager is provided with corrective actions that are required, and thereafter, the system documents any data changes that occur. Additionally, the data from a plurality of laboratories is stored in the central laboratory to allow for peer review across laboratories. The system allows for monitoring the laboratory, identifying and fixing issues, and document all aspects for regulatory compliance, including allowing instant regulatory access to laboratory logs.

### CROSS-REFERENCE TO RELATED APPLICATIONS

This is a non-provisional application of U.S. Provisional Application No. 61/707,471, filed on Sep. 28, 2012, and entitled, “MY LAB”™.

### BACKGROUND OF THE INVENTION

(1) Field of Invention

The present invention relates to an integrated lab management system and, more particularly, to an online virtual lab manager that follows through and allows for electronic documentation and management of all aspects of lab management and compliance.

(2) Description of Related Art

The present invention is directed to the field of lab management. The Centers for Medicare & Medicaid Services (CMS) regulates all laboratory testing (except research) performed on humans in the U.S. through the Clinical Laboratory Improvement Amendments (CLIA). In total, CLIA covers approximately 225,000 laboratory entities. The CLIA regulates the labs and issues certificate of compliance (inspected by CMS or its agents), a certificate of accreditation, a certificate of provider performed microscopy and a certificate of waiver for labs doing waived tests.

In order for a laboratory to receive and maintain a license, the laboratory has to demonstrate compliance with, at a minimum, CLIA regulations. In doing so, the laboratory needs to have or do the following:
1. Policies and procedures.
2. Meet the personnel requirements.
3. Have evidence of performance evaluation of personnel.
4. Instrument validation, calibration, maintenance and periodic calibration validation logs.
5. Temperature logs.
6. Quality Control (QC) plan. Periodic review of QC logs and corrective actions.
7. Quality Assurance (QA) plan to cover all phases of the lab (pre-analytical, analytical and post analytical). It includes oversight of all aspects of the lab and documentation of all actions and reviews.
8. Proficiency testing (blind samples received on 2 to 3 challenges per year and graded). The laboratory must get at least 80% (target is always 100%). Any failure needs to be investigated and documented. Repeat failures can lead to sanctions and a cessation of testing abilities for the lab.

Currently, laboratories use human managers or technical consultants to stay in compliance. A persistent problem with existing protocol is proficiency testing failures and when the QA plan is not implemented (QC failures with no correction).

The present invention addresses these issues and offers an online virtual laboratory manager that follows through and allows for electronic documentation of all aspects of the laboratory.

### SUMMARY OF INVENTION

The present invention relates to an integrated laboratory management system and, more particularly, to an online virtual laboratory manager that follows through and allows for electronic documentation and management of all aspects of laboratory management and compliance.

In one aspect, the system includes one or more processors and a memory. The memory is encoded with instructions such that upon execution of the instructions, the one or more processors perform several operations as described herein. For example, the system receives data from one or more instruments in a laboratory and stores the data in a central library. The data is compared against compliance target values to determine if the one or more instruments are in compliance, and if the data is out of the compliance target values, notifying a laboratory manager. In notifying the laboratory manager, the laboratory manager is provided with corrective actions that are required, and thereafter, the system documents any data changes that occur.

In another aspect, the system receives data from one or more instruments in a plurality of laboratories and stores the data from the plurality of laboratories in the central library. The data from one laboratory is compared against data from another laboratory to detect any anomalies in the one or more instruments. Further, a laboratory manager is notified if an anomaly is detected.

In yet another aspect, the central library includes log entries for the one or more instruments in a laboratory, and is adapted to allow a regulator to review, online, the log entries to assess regulatory compliance of the laboratory.

In another aspect, the system stores personnel data, including licensure and continuing education requirements and compliance with the licensure and continuing education requirements. The system also stores and provides documents to select personnel that include policies and procedures as required for laboratory compliance and, further, receives and stores an electronic signature on the documents as applicable and/or required.

Finally, the present invention also includes a computer implemented method and computer program product. The method comprises an act of causing a computer (e.g., one or more processors) to execute instructions encoded on a memory, such that upon execution, the computer performs the operations described herein. Similarly, the computer program product includes such instructions encoded on a non-transitory computer readable medium.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of computer system according to the principles of the present invention;

FIG. 2 is an illustration of a computer program product embodying an aspect the present invention; and

FIG. 3 is an illustration of a flow chart depicting information flow according to the principles of the present invention.

### DETAILED DESCRIPTION

The present invention relates to an integrated laboratory management system and, more particularly, to an online virtual laboratory manager that follows through and allows for electronic documentation and management of all aspects of laboratory management and compliance. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set than in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a description of various principal aspects of the present invention is provided. Subsequently, an introduction provides the reader with a general understanding of the present invention. Finally, specific details of the present invention are provided to give an understanding of the specific aspects.

(1) Principal Aspects

The present invention has three “principal” aspects. The first is a laboratory management system. The laboratory management system is typically in the form of a computer system operating software or in the form of a “hard-coded” instruction set. This system may be incorporated into a wide variety of devices that provide different functionalities. Further, the system may be in a single processor and/or accessible online and/or distributed amongst many processors. Importantly, the system includes one or more processors and a memory that are configured (via code, etc.) to perform the all of the functions as described herein. The second principal aspect is a method, typically in the form of software, operated using a data processing system (computer). The method comprises acts of causing a computer to perform the operations and functions listed herein. Finally, the third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. The computer program product includes instructions that, when executed by a computer, cause the computer to perform the operations and functions described herein. These aspects will be described in more detail below.

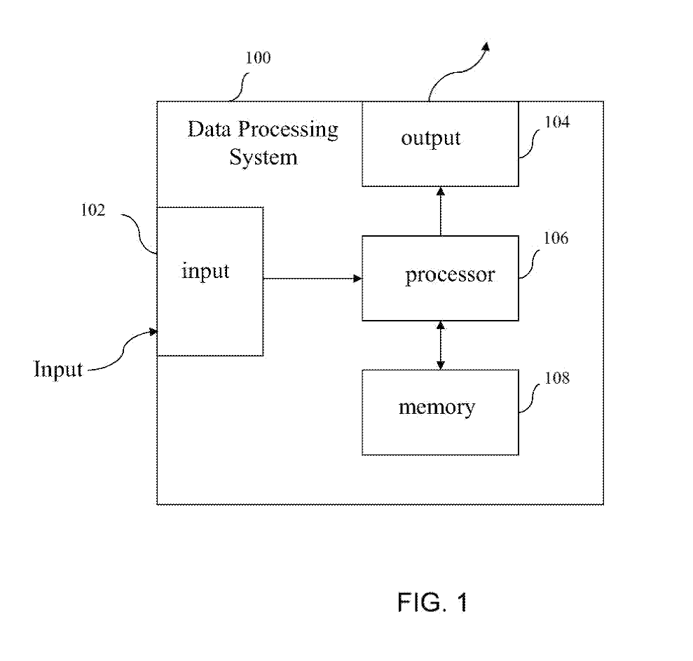

A block diagram depicting the components of an aspect of a laboratory management system of the present invention is provided in FIG. 1. The laboratory management system 100 comprises an input 102 for receiving information from the various components described herein, non-limiting examples of which include sensors, log entries, peer data, and sensor inputs (e.g., temperatures of refrigerators, incubators, rooms, freezers, etc.). Note that the input 102 may include multiple “ports.” An output 104 is connected with the processor for providing information regarding the laboratory to a user or other systems in order that a network of computer systems may serve as a laboratory management system. Output may also be provided to other devices or other programs; e.g., to other software modules, for use therein. The input 102 and the output 104 are both coupled with one or more processors processor 106, which may be a general-purpose computer processor or a specialized processor designed specifically for use with the present invention. The processor 106 is coupled with a memory 108 to permit storage of data and software that are to be manipulated by commands to the processor 106.

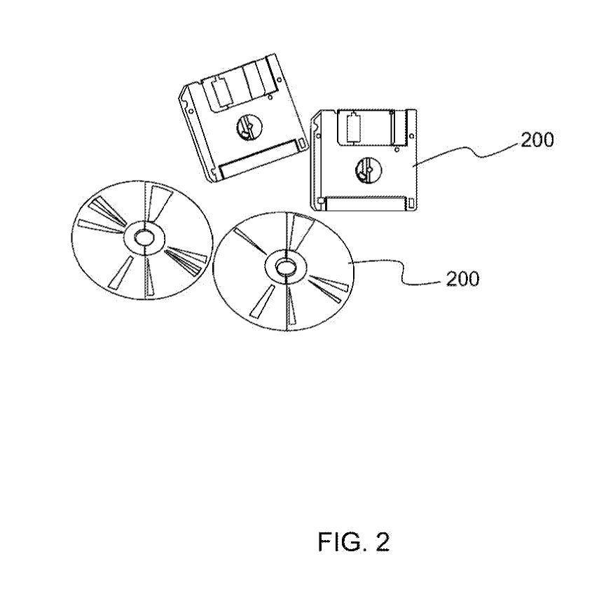

An illustrative diagram of a computer program product embodying an aspect the present invention is depicted in FIG. 2. The computer program product 200 is depicted as an optical disk such as a CD or DVD. However, as mentioned previously, the computer program product generally represents computer-readable instructions stored on any non-transitory compatible computer-readable medium. The term “instructions” as used with respect to this invention generally indicates a set of operations to be performed on a computer, and may represent pieces of a whole program or individual, separable, software modules. Non-limiting examples of “instructions” include computer program code (source or object code) and “hard-coded” electronics (i.e. computer operations coded into a computer chip). The “instructions” may be stored in the memory of a computer or on any non-transitory computer-readable medium such as a floppy disk, a CD-ROM, and a flash drive.

(2) Introduction

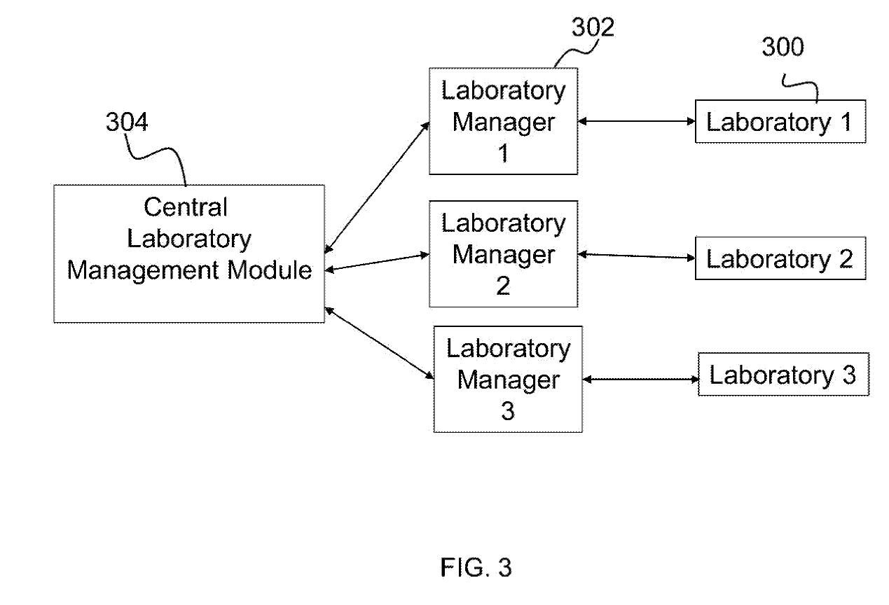

The present invention a virtual laboratory that is designed to assist with the startup and ongoing monitoring/management of clinical laboratories via a compliance-focused and rules-based intelligent software solution. The system is designed to provide support, management, and oversight that has been traditionally provided by laboratory managers and consultants. The system simplifies the complex compliance requirements, introduces standards and conformity resulting in compliance and care consistencies. An example schematic of the system is provided in FIG. 3, which illustrates that the various laboratories 300 or laboratory components that send and receive information to/from laboratory manager modules 302 and the central laboratory management module 304 for oversight and analysis. The central laboratory management module 304 is the operational brains of the system. The central laboratory management module 304 provides consistencies for all oversight and captures data for comparison and analysis (inter and intra).

In essence, the system includes a laboratory manager 302 that can be unique for each laboratory and/or user. The laboratory manager 302 is the module that individual lab managers access to monitor and manage their laboratory 300 equipment/components. Each laboratory manager 302 sends/receives data from the laboratory 300 equipment, which is then passed along to the central laboratory management module 304. The central laboratory management module 304 provides standardized documentation and documents that can be accessed via the corresponding laboratory manager 302 to ensure that all of the specific laboratory 300 equipment/policies, etc. are in compliance.

Thus, the present invention provides the laboratory with a controlled system of oversight and standardized documentation and document control. Each laboratory is typically subject to an inspection every two years from the Clinical Laboratory Improvement Amendments (CLIA) and the Centers for Medicare & Medicaid Services (CMS) or an accrediting agency. If the laboratory has a fully integrated and electronic system (as provided by the present invention), the system can offer the inspector a virtual lab inspection by granting the inspector access to review all documentation online prior to an on-site visit. This will allow the potential survey to be short and reduce the time that an inspector spends on-site, thus increasing efficiency and time requirements for inspection. The system can be tailored to assist the inspector in navigating through documentation and allowing the inspector either to setup a plan of document review (select what sequence) or point out areas where a particular laboratory had failures (via quality control (QC) or proficiency) and the corrective actions that are required.

(3) Specific Details

As noted above, the present invention provides the monitoring and compliance of laboratory 300 components/policies, etc. by coordinating data received from the laboratory 300 with a central laboratory management module 304. A laboratory operator uses a laboratory manager module 302 review the material and ensure overall laboratory compliance. The laboratory manager module 302 can simply be a self-contained program or a portal into a user account (and corresponding laboratory info) at the central laboratory management module 304. In either event, a unique aspect of the system is the adaptation and integration of the system components which provide for monitoring (e.g., 24 hours a day, 7 days a week) and notification. When all the system components are working together, automatic oversight will be in place for a laboratory facility to maintain certification and provide regulators online access for routine inspection items. Each of the system components can stand alone—but together they create a facility that is run by a virtual lab manager. While some of the communication links can be wireless, in some aspects and as needed, the system has physical links to laboratory equipment, with the primary programs and data storage being stored on servers either on-site or in the cloud.

The central laboratory management module 304 is a learning system that builds a library resource for all sytem-wide laboratories/regulators. It can gather data from a number of different laboratories (and their laboratory manager modules 302) to coordinate into a library resource.

To effectively manage the various aspects, policies, procedures, and equipment of a laboratory, the present invention includes several integrated modules that are incorporated into the system. Each of the integrated modules can be incorporated into any or all of the relative components as applicable, necessary, or desired, including the laboratory components 300 any/all laboratory instruments equipment (refrigerators, temp monitoring), etc.), the laboratory manager module 302 and the central laboratory management module 304. Notably, all of the incremental modules can be included in the 24×7 monitoring.

Thus, the system includes several unique and collectively integrated modules, as described in further detail below.

The data capture module (or My-Link™) is a functional module that includes the relevant software and/or hardware (middleware) for instrument data capture and transmission of such data to the other relevant components/modules described herein. The data capture module connects to instruments (i.e., laboratory components 300) to acquire data. The data capture module is an interlace engine that resides in the laboratory on a computer or other device (e.g., PC) and connects (e.g., using any technique, such as wireless or RS232/serial comport, etc.) to equipment. The data capture module generally includes two options, such as (1) data acquisition with NO data management, or (2) data acquisition with data management.

The data capture module provides the data for the quality control module (or My-QC™) and is typically housed and integrated with the lab manager module 302. The data capture module is to be contrasted with the other integrated modules which desirably (although not required) reside in the cloud or other external servers (e.g., as part of the central laboratory management module 304) to provide the virtual laboratory management services. Importantly, because much of the client's data is stored in the central laboratory management module 304, each client's data is maintained securely. Having said that, the statistical reporting (described below) collects data from like equipment, across labs for peer reviews.

Another relevant module is the policy module (or My-Policies™). In the policy module, electronic policies or procedures are reviewed annually by a laboratory director. Non-limiting examples of such policies or procedures are policies or procedures that are or may be required for laboratory compliance. These policies will be available for the laboratory from general policies to test specific policies or procedures. Each policy is customized for the individual laboratory and allows for additions. All policies are available in PDF format (or any other suitable format) online (with electronic signatures). Typically, it is also required that a printed copy of many of the policies or procedure must be available in the physical laboratory.

Another module, the quality control module (or My-QC™) allows for comparison against target values as well as peer data. The quality control module allows for real-time comparison and gives the laboratory the opportunity to get real-time data review and assessment of their performance in comparison to peers. As can be appreciated, the system builds a library with all of the data that is maintained and recorded across multiple laboratories and vendors (i.e., peers). For example, because data is provided via the data capture module to the central laboratory management module 304 (where it is stored), the data from any individual laboratory (e.g. and its laboratory components 300) can be compared against the data from other laboratories to detect any anomalies.

Any failures for quality control will have documentation and all rules will be applied to assure compliance. A cumulative and/or statistical report can be generated automatically, by date or on demand.

For further understanding, an example operating procedure as applicable to the quality control module is as follows:
a. Quality control data is collected from instruments laboratory components 300) in the laboratory. While data can be entered manually, ideally, the system collects automated data, such as temperature (via temperature sensors, etc.), etc. In one aspect, the quality control data can be collected using the data collection module which is then transmitted per the operations described herein.
b. The data is stored. As a non-limiting example, the data is stored in the central laboratory management module 304, which stores the individual laboratories data and also builds a library for peer analysis and comparison.
c. The data is analyzed. The analysis can be done by comparing the data with required values provided by the CLIA and/or peer results, as needed or in real-time as the data is captured. A unique aspect of the present invention is that it can provide peer analysis across multiple vendors (i.e., comparison of one laboratories' data with that of other laboratories) to identify anomalies. For example, a certain model of refrigerator may require that the actual settings of that model must be lower than would normally be expected to maintain the optimal temperatures. On its own, the laboratory operator may believe that there is an issue with the refrigerator. However, when compared with other laboratories that use the same model, it is noticed that it is not an anomaly and is in fact normal for that particular model. Further, to monitor compliance, the quality control data is collected and compared to compliance target values, which are used as a compliance guide. As a non-limiting example, the system can monitor to ensure that a refrigerator temperature is maintained between 1 and 8 degrees Celsius.
d. Reports can be generated to provide a statistical analysis as to compliance and/or peer review.
e. Importantly, the quality control module provides for automated compliance tracking. When the quality control data is out of the target ranges that are indicative of rules compliance, the system documents the correction action that is needed.
f. The system then provides the laboratory manager notification of the QC issue and provides pre-formed comments for correction actions to address the applicable QC issue. The system also allows for free text entry and further captures data to indicate what corrective action was taken. For example, if a refrigerator was below a range of compliant temperature ranges, the laboratory manager is notified of the QC issue and that the temperature should be adjusted to be within the compliant temperature ranges. In one aspect, if the adjustments are made, the data collection module gathers the data changes (such as a change in the input temperature or sensed temperature) and transmits the changes for recordation and documentation by the quality control module.

Thus, as can be appreciated, the quality control module proactively monitors the laboratory using rules and algorithms to help prevent errors. The system allows for pre-emptive address of issues and repairs. Expert systems begin with rule-based knowledge and will continue to learn and do interpretive analysis providing suggestions for corrective actions and/or recommendations. For example, the system monitors instrument performance through data analysis. The expert information (e.g., compliance rules) is coded into the system to ensure laboratory compliance.

Thus, the quality control modules watches for signs of problems and provides for a predictive-based situation analysis (which allows for preventative measures to be implemented). It should be understood that it also is a real-time (not just predictive) detector of issues when a measurement, etc. falls outside of a predefined range or is determined to be anomalous. In such a case, the system accesses its library to determine a possible fix and presents the possible fix to the user. For example, if a system or result fails a test, the question is “what did I do”? The system can then provide a possible solution based on the collective input, such as “did not run quality control procedures.”

Another module is the personnel module (or My-Personnel™). The personnel module can be used to store data and documents with respect to the personnel of a particular laboratory. For example, the personnel module is used to store personnel job descriptions, review, performance review, counseling, training and any other data as pertinent to performance in the laboratory. The system can also provide documents for compliance or personnel matters. For example, all documents are electronically signed and sealed in PDF format (or any other suitable format).

It should be noted that the documentation and personnel files will be maintained as required by law. For example, certain regulations exist regarding personnel file and patient files and who can have access to such files e.g., confidentiality rules). Thus, in one aspect, access to the relevant personnel and/or patient information is granted only to those who have clearance for such information. This can be managed through account profiles and passcodes. As a non-limiting example, certain account user may have access to all information while other account users may only have access to instrument logs. In another aspect, passcodes may be required to access certain sensitive data.

The personnel module can also track human resource management (HRM) issues as required by regulators (including continuing education). A unique aspect is that the system incorporates all of the elements required to be CLIA compliant online, in real time. In other words, all documents needed for laboratory compliance are stored online, reviewed, and are up to date and available for online regulatory review. The documents can also be formatted to be available in PDF form (or any other suitable form) and provided as templates or other material as required. The personnel module can also be used to capture and maintain all of the HRM requirements, such as staff licensure requirements and details of staff licensing, continuing education requirements and details of staff continuing education completions, files, etc. This also provides an electronic document management system that includes policies and procedures and the documentation required by a laboratory with electronic signature capability.

Another operable module is the temperature module (or My-Temp™). The temperature module maintains temperature logs for the laboratory (e.g., room temperature and humidity), refrigerators, freezers, incubators and any other device that is controlled by a thermostat. Thus, the temperature module provides for online recording of temperatures to ensure or monitor compliance with temperature requirements. The system links temperature sensors in some equipment, refrigerators, freezer, and rooms with the data capture module, which transmits and stores it in the data temperature module (which can be a part of the laboratory manger module 302 and/or the central laboratory management module 304. Manual entry of temperature data can also be entered and maintained in the temperature logs. Thus, the temperature module allows a laboratory manager to monitor, track and record temperature data. Further, notification of problems can be provided instantly (via text, email, phone call, etc.) when no one is in the laboratory and/or when problems occur (i.e., the temperature falls outside of a predefined range of values). As an advantage over the prior art, the monitor, track, and record feature is incorporated into the fully compliant lab management system of the present invention.

A module similar to the temperature module is the instrument log module (or My-Instrument™). The instrument log module maintains an instrument log that logs maintenance records (daily, weekly, monthly, quarterly and annually), validation data, calibration verification data (e.g., minimum every six months unless there is an exception), repairs (e.g., vendor repairs), and any other records of any other instrument issues. Thus, the instrument log module maintains logs as required for compliance, all of which can be monitored, tracked, and reported online. The system automatically captures necessary information, similar to other components, and provides notifications when problems arise to allow for pre-emptive repair.

To further assist laboratories in compliance, the system includes a proficiency module (My-Proficiency™). The proficiency module requires that all (or some, as desired or registered) laboratories are required to enroll in proficiency program(s) to maintain certification. The proficiency program provides challenges in which sample tests (e.g., blind samples) are completed by the laboratory and results are returned to a proficiency testing agency. The current process for proficiency testing is through manually completing forms and submitting the forms via mail, fax or online, to the testing agency, after which grades are provided. With the data capture module of the present invention, the testing data is captured and transmitting through the modules for submission directly to the testing agency (e.g., online). The proficiency testing agencies provide proficiency test results to the laboratory and the inspecting agency, with a goal of assuring quality monitoring of laboratory testing without any patient harm. Thus, proficiency requires the investigation and documentation of testing results and corrective actions and signatures. To increase efficiencies, the present invention maintains all of this electronically through the integrated computer modules described herein. The proficiency module also provides for quality assurance (QA) procedures, such as QA review and documentation of findings and corrective actions when needed. This includes maintaining records of audits and audit trails.

In operation, a client logs into their individual system (via the laboratory manager module 302) which overlays and shares the entire laboratory repository (i.e., the central laboratory management module 304), but contains the individual laboratories' (or user) data and customizations. In a real world scenario, different people work in the laboratory, monitoring everything, using the equipment, and handling activities on a daily, weekly, and monthly basis. They are all seeing, doing different things and they may miss correlations that the system will not miss (within the laboratory). Currently, lab technicians do not have online real-time access to correlations that may be occurring across other labs (i.e., similar equipment). There may be a predictive-based situation that can be avoided given the present invention. The virtual oversight provides a level of consistency and standardization that is not possible with only human management. Although the present invention does not replace the human element entirely, it does improve quality standards relating to improvements in patient care. By building the library of multiple laboratory data, the peer comparisons provide higher quality analysis and increased efficiencies to all laboratories in the collaboration.

For example, if a laboratory had a particular problem, it would be desirable to identify the source of the problem, its remedy, and document the process to improve and address the problem. In an isolated laboratory, the laboratory manager would need to encounter each problem and attempt to determine the remedy. While an individual laboratory manger can learn from his/her mistakes, the laboratory manager does not typically have a collective resource, remedy, documentation and the process improvement system required for ongoing compliance at his/her fingertips. Alternatively, all of these items and processes are automatically provided and documented using the integrated lab management system of the present invention. The processes, procedures, results, and documentation of a particular laboratory are recorded and maintain in a central virtual library.

As an added feature over existing systems, the virtual library allows for a virtual laboratory inspections that provides regulatory agencies the ability to inspect the laboratory anytime without disruption (as opposed to physically entering the laboratory to review paperwork, etc.). In other words, the system is available online for regulators to view log entries of all the modules, instruments and equipment.

What is claimed is:

1. A laboratory management system, comprising:
one or more processors and a memory, the memory having instructions encoded thereon, such that upon execution of the instructions by the one or more processors, the one or more processors perform operations of:
receiving data from one or more instruments in a laboratory;
storing the data in a central library; and
comparing the data against compliance target values to determine if the one or more instruments are in compliance, and if the data is out of the compliance target values, notifying a laboratory manager.

2. The laboratory management system as set forth in claim 1, wherein in notifying the laboratory manager, the laboratory manager is provided with corrective actions that are required, and thereafter, the system documents any data changes that occur.

3. The laboratory management system as set forth in claim 2, wherein the memory further includes instructions for causing the one or more processors to perform operations of:
receiving data from one or more instruments in a plurality of laboratories;
storing, the data from the plurality of laboratories in the central library; and
comparing data from one laboratory against data from another laboratory to detect any anomalies in the one or more instruments; and
notifying a laboratory manager if an anomaly is detected.

4. The laboratory management system as set forth in claim 3, wherein the central library includes log entries for the one or more instruments in a laboratory, and wherein the central library is adapted to allow a regulator to review, online, the log entries to assess regulatory compliance of the laboratory.

5. The laboratory management system as set forth in claim 4, wherein the memory further includes instructions for causing the one or more processors to perform operations of:
storing personnel data, including licensure and continuing education requirements and compliance with the licensure and continuing education requirements;
storing and providing documents to select personnel that include policies and procedures as required for laboratory compliance; and
receiving and storing an electronic signature on the documents.

6. A computer program product for managing a laboratory, the computer program product comprising computer-readable instructions stored on a non-transitory computer-readable medium that are executable by a computer having a processor for causing the processor to perform operations of:
receiving data from one or more instruments in a laboratory;
storing the data in a central library; and
comparing the data against compliance target values to determine if the one or More instruments are in compliance, and if the data is out of the compliance target values, notifying a laboratory manager.

7. The computer program product as set forth in claim 6, wherein in notifying the laboratory manager, the laboratory manager is provided with corrective actions that are required, and thereafter, the system documents any data changes that occur.

8. The computer program product as set forth in claim 7, further comprising instructions for causing the one or more processors to perform operations of:
receiving data from one or more instruments in a plurality of laboratories;
storing the data from the plurality of laboratories in the central library; and
comparing data from one laboratory against data from another laboratory to detect any anomalies in the one or more instruments; and
notifying a laboratory manager if an anomaly is detected.

9. The computer program product as set forth in claim 8, wherein the central library includes log entries for the one or more instruments in a laboratory, and wherein the central library is adapted to allow a regulator to review, online, the log entries to assess regulatory compliance of the laboratory.

10. The computer program product as set forth in claim 9, further comprising instructions for causing the one or more processors to perform operations of:
storing personnel data, including licensure and continuing education requirements and compliance with the licensure and continuing education requirements;
storing and providing documents to select personnel that include policies and procedures as required for laboratory compliance; and
receiving and storing an electronic signature on the documents.

11. A computer-implemented method for managing a laboratory, comprising:
an act of causing a data processor to execute instructions stored on a non-transitory memory such that upon execution, the data processor performs operations of:
receiving data from one or more instruments in a laboratory;
storing, the data in a central library; and
comparing the data against compliance target values to determine if the one or more instruments are in compliance, and if the data is out of the compliance target values, notifying a laboratory manager.

12. The computer implemented method as set forth in claim 11, wherein in notifying the laboratory manager, the laboratory manager is provided with corrective actions that are required, and thereafter, the system documents any data changes that occur.

13. The computer implemented method as set forth in claim 12, further comprising operations of:
receiving data from one or more instruments in a plurality of laboratories;
storing the data from the plurality of laboratories in the central library; and
comparing data from one laboratory against data from another laboratory to detect any anomalies in the one or more instruments; and
notifying a laboratory manager if an anomaly is detected.

14. The computer implemented method as set forth in claim 3, wherein the central library includes log entries for the one or more instruments in a laboratory, and wherein the central library is adapted to allow a regulator to review, online, the log entries to assess regulatory compliance of the laboratory.

15. The computer implemented method as set forth in claim 4, further comprising operations of:
storing personnel data, including licensure and continuing education requirements and compliance with the licensure and continuing education requirements;
storing and providing documents to select personnel that include policies and procedures as required for laboratory compliance; and
receiving and storing an electronic signature on the documents.
